(19) United States
(12) Patent Application Publication
(10) Pub. No.: US 2021/0015294 A1
(43) Pub. Date: Jan. 21, 2021

(54) COFFEE POWDER STIRRER FOR FILTER HOLDER OF ESPRESSO MACHINE

(71) Applicant: Modern Co., Ltd., DongGuan City (CN)

(72) Inventor: Chunchih LIN, DongGuan City (CN)

(73) Assignee: Modern Co., Ltd., DongGuan City (CN)

(21) Appl. No.: 16/929,052

(22) Filed: Jul. 14, 2020

(30) Foreign Application Priority Data
Jul. 15, 2019 (CN) 201921103081.2

(51) Int. Cl. A47J 31/36

(52) U.S. Cl. CPC A47J 31/3619; A47J 31/4403

(57) ABSTRACT

Provided is a coffee powder stirrer that includes a lid. The top of the lid is provided with a through hole. A supporting rod is inserted through the through hole. The top of the supporting rod is connected to an operating member. A spring is provided between the operating member and the lid. The spring is sleeved on the supporting rod. A stirring assembly is provided in a cavity of the lid, and is secured to the bottom of the supporting rod. The lid is engaged with a coffee powder box so as to prevent coffee power from spilling out of the coffee powder box in a stirring process. The supporting rod pushes the stirring assembly to break up caked coffee powder. The cooperation between the spring and the operating member fulfills the restoration of the stirring assembly and facilitates rapid breakup of the caked and glutinous coffee powder.

### CROSS-REFERENCE TO RELATED APPLICATIONS

The present application claims the benefit of Chinese Patent Application No. 201921103081.2, filed on Jul. 15, 2019, the entirety of which is hereby incorporated by reference for all purposes.

### TECHNICAL FIELD

The present utility model relates to the field of daily necessities, and more particularly relates to a coffee powder stirrer.

### BACKGROUND

Coffee powder may cake in many external environments such as heavy pressure, natural storage, or moisture. Caking of the coffee powder may affect the heating and water absorption of the coffee powder, thus affecting the taste and concentration of the brewed coffee and resulting in waste at the same time.

When a high-pressure coffee machine is used to fill the coffee powder into the coffee powder box, the coffee powder may cake in the coffee powder box. There is currently no agitator available on the market which can be used in cooperation with the coffee powder box of the high-pressure coffee machine. As such, most people would stir the caked coffee power using a bamboo stick, a steel needle, or an egg beater. However, the powder box of the high-pressure coffee machine has a very small space, such that coffee powder is easy to spill out during the stirring process, and in order to prevent the coffee powder from spilling out, more time is required to stirring uniformly within a small range and at low speeds for many times.

### SUMMARY

The object of the present utility model is to provide a coffee powder stirrer which can quickly break up the caked coffee powder in the coffee powder box while preventing the coffee powder from spilling out of the coffee powder box.

To achieve this object, the present utility model provides the following solutions.

There is provided a coffee powder stirrer that includes a lid. A top of the lid is provided with a through hole. A supporting rod is inserted through the through-hole. One end of the supporting rod protrudes out of the top of the lid. An operating member is mounted on a part of the supporting rod that protrudes out of the top of the lip. The operating member is configured to drive the supporting rod into motion. A stirring assembly is mounted on the supporting rod and disposed in the cavity of the lid.

### BRIEF DESCRIPTION OF DRAWINGS

FIG. 1 is a perspective view of a coffee powder stirrer according to an example of the present utility model;

FIG. 2 is an exploded view of FIG. 1;

FIG. 3 is a perspective view of a lid of a coffee powder stirrer according to an example of the present utility model; and

FIG. 4 is an exploded view of FIG. 3.

In the drawings: 1. Operating member; 2. Spring; 3. Vibration assembly; 31. Driving member; 32. Upper base; 33. Lower base; 4. Lid; 41. Through hole; 42. Upper lid body; 43. Lower lid body; 5. Supporting rod; 51. External thread; 6. Stirring assembly; 61. Connecting plate; 63. Stirring needle; 7. Gasket.

### DETAILED DESCRIPTION

To provide a better understanding for the problems to be solved, solutions that are adopted and the effects achieved of the present utility model, the solutions of the present utility model will now be described in connection with drawings and embodiments. Apparently, the embodiments described below are merely part rather than all of the embodiments of the present utility model.

### Embodiment One

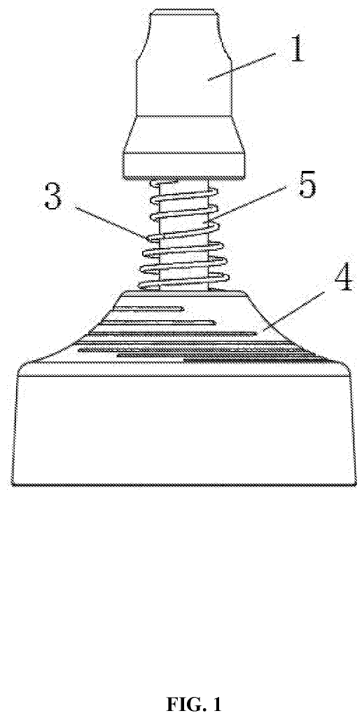

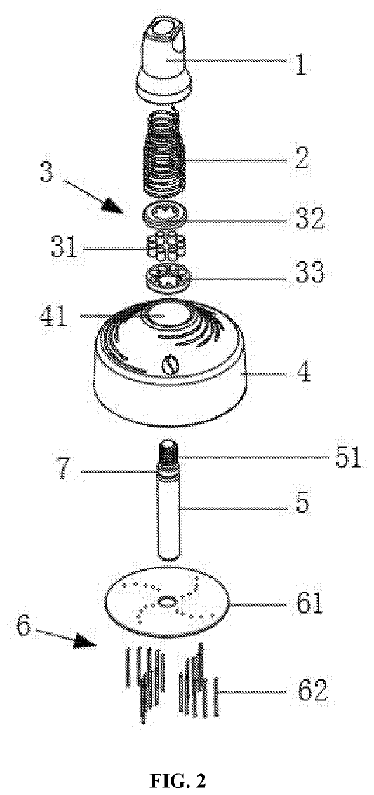

Referring to FIGS. 1 and 2, a coffee powder stirrer is provided. The stirrer includes a lid 4. A top of the lid 4 is provided with a through hole 41. A supporting rod 5 is inserted through the through hole 41. The top of the supporting rod 5 is connected to an operating member 1. A spring 2 is provided between the operating member 1 and the lid 4. The spring 2 is sleeved on the supporting rod 5. A stirring assembly 6 is provided in the cavity of the lid 4, and is secured to the bottom of the supporting rod 5.

Typically, the stirring assembly 6 includes a connecting plate 61 and a plurality of stirring needles 62. The connecting plate 61 is secured to the bottom of the supporting rod 5, and the stirring needles 62 are vertically arranged and secured to the bottom of the connecting plate 61.

In use, the upper lid body of the coffee powder box is opened, and the lid 4 is placed on and covered on the coffee powder box, so that the stirring needles 61 are point to the coffee powder in the coffee powder box. A force that points to the coffee powder box is applied to the operating member 1 to drive the supporting rod 5 to move so as to press the spring 2 and, meanwhile, to drive the connecting plate 61 into motion so that the stirring needles 62 are inserted into the coffee powder to break up the caked coffee powder. When the force is removed from the operating member 1, the operating member 1 is restored by a restoring force of the spring 2. This operation is repeated several times so that the caked and glutinous coffee powder can be quickly and totally broken up in a few seconds. Meanwhile, the lid 4 covers the coffee powder box to prevent the coffee powder from spilling out of the coffee powder box. The coffee powder stirrer has a simple structure and strong practicality. The cooperation between the spring and the operating member fulfills the restoration of the stirring assembly and facilitates rapid breakup of the caked and glutinous coffee powder.

Typically, the coffee powder stirrer further includes a vibration assembly 3. The vibration assembly 3 is arranged above the stirring assembly 6 and configured to drive the stirring assembly 6 to move upwards to collide with the lid 4. Because the stirring needles 62 are inserted into the coffee powder, some of the coffee powder sticks to the surfaces of the stirring needles 62 and, together with the stirring needles 62, leaves the coffee powder box. The vibration assembly 3 serves a function of accelerating the upward movement of the stirring assembly 6 when the stirring needles 62 move upward under the restoring force of the spring 2, so that the connecting plate 61 can collide with the top of the lid 4 at a higher speed, thereby generating vibration to shake off the coffee powder that sticks to the surfaces of the stirring needles 62, thereby reducing the coffee powder loss and achieving the purpose of self-cleaning of the stirrer.

In particular, the vibration assembly 3 may include a base and a driving member 31. The base may include an upper base 32 and a lower base 33. The upper base 32 and the lower base 33 surround the supporting rod 5 and are secured to the inner wall of the through hole 41. The upper base 32 and the lower base 33 are fitted to form an accommodating cavity, and the driving member 31 is secured to the accommodating cavity.

Typically, the stirring assembly 6 and the vibration assembly 3 may be magnetic members, and the vibration assembly 3 may attract the stirring assembly 6 to accelerate towards the top of the lid 4 and collide with the lid 4.

Typically, the connecting plate 61 and the stirring needles 62 are both implemented as magnetic members. Specifically, in this embodiment, the connecting plate 61 and the stirring needles 62 are both implemented as steel, and the stirring assembly 6 is implemented as a magnet. The steel has high hardness and is not vulnerable to rust, and can attract the stirring assembly 6 made of the magnet, so that the stirring assembly 6 can be accelerated to collide with the lid 4, thereby generating vibration.

In other embodiments, only the connecting plate 61 or the stirring needles 62 in the stirring assembly 6 are implemented as a magnetic member. Similarly, the base or the driving member 31 of the vibration assembly 3 may be integrally formed, that is, the vibration assembly 3 is a separate magnet and is secured to the top of the lid 4 by means of a buckle, screw, or adhesive.

Each stirring needle 62 is arranged vertically downwards and has the same length. An existing coffee powder box may have a diameter that lies in the range from 49 mm to 58 mm. In view of the coffee powder box within this diameter range taken in conjunction with the viscosity and particle sizes of the coffee powder, the number of the stirring needles 62 may typically be set to be 20 to 30. Actually, too few stirring needles 62 cannot ensure that most of the coffee powder be scattered, but too many stirring needles 62 can generate an excessively large internal extrusion pressure in the coffee powder box in the process of rotary stirring, which may produce adverse effects, such as contributing to the caking and increasing the resistance in using the twisting operating member 1 making it difficult to twist the operating member 1.

Typically, the stirring needles 62 are arranged on the connecting plate 61 in a spiral four-direction layout. When the operating member 1 is rotated clockwise, the stirring needles 62 generate a centripetal force that pushes the coffee powder inwards. When the operating member 1 is rotated counterclockwise, the stirring needles 62 generate a centrifugal force that pushes the coffee powder outwards to break up the coffee powder in a circular and uniform manner. In other embodiments, the stirring needles 62 may also be arranged in different orientations, different numbers, different layouts, or different lengths, where the stirring needles 62 in such arrangement can also break up the caked coffee powder.

In this embodiment, the base is implemented as steel, the driving member 31 is a magnet, and the driving member 31 is secured to the base through magnetic attraction.

Typically, the coffee powder stirrer further includes a plurality of gaskets 7 that are arranged under the operating member 1, and when the operating member 1 descends to the lower limit, the gaskets 7 are jacked up by taking the lid 4 as a fulcrum, so that the descending stroke of the operating member 1 is shortened. Further, the descending stroke of the stirring assembly 6 driven by the supporting rod 5 is shortened, such that the depth of the stirring needles 62 inserted into the coffee powder box is reduced, and the agitator can be suitable for coffee powder boxes with different depths. The number of the gaskets 7 is adjusted to determine the depth of insertion of the stirring needles 62 into the coffee powder box. In particular, the more gaskets 7 are arranged, the shallower depth of the stirring needles 62 inserted into the coffee powder box is; the fewer gaskets 7 are arranged, the greater depth of the stirring needles 62 inserted into the coffee powder box. When there are provided no gaskets 7, the depth of the stirring needles 62 into the coffee powder box reaches the maximum.

Typically, the gasket 7 is hollow, and the gasket is sleeved on the supporting rod 1 and arranged between the operating member 1 and the spring 2.

In addition, to make it easy to arrange a proper number of gaskets 7 around the supporting rod 5, the supporting rod 5 and the operating member 1 are detachably connected, so that the operating member 1 can be taken down from the supporting rod 5 and the gaskets 7 are mounted. In particular, in this embodiment, the top of the supporting rod 5 is provided with an external thread 51, the bottom of the operating member 1 is provided with an internal thread, and the supporting rod 5 is in a threaded connection with the operating member 1.

In this embodiment, it is operative to rotate the operating member 1 to drive the stirring needles 62 to stir the coffee powder, so as to break up the caked and glutinous coffee powder.

### Embodiment Two

Embodiment two is different from Embodiment one in that the spring 2 is not provided in Embodiment two, and the length of the stirring needles 62 is increased so that the stirring needles 62 can protrude from the lid 4. When used, the lid 4 is covered on the coffee powder box, the stirring needles 62 can be inserted into the coffee powder, the operating member 1 is rotated, the stirring needles 62 are driven to stir the caked coffee powder, thereby scattering the caked and sticky coffee powder.

Typically, a stopper is provided to limit the degree of freedom of the supporting rod 5 in the vertical direction so that the operating member 1 is rotated without simultaneously applying downward pressure to the supporting rod 5 thus the stirring needles 62 are not disengaged from the coffee powder during stirring.

### Embodiment Three

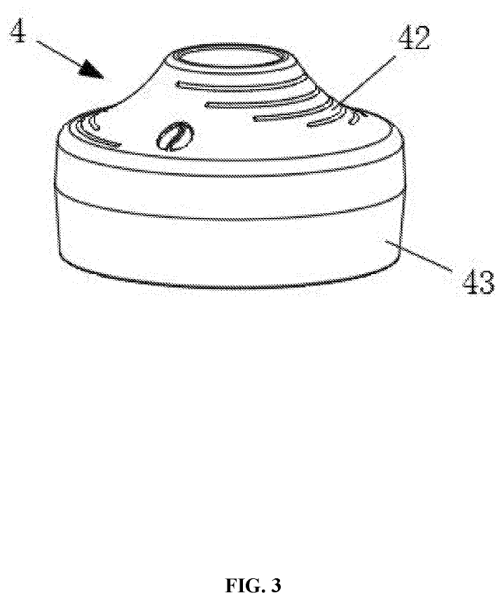

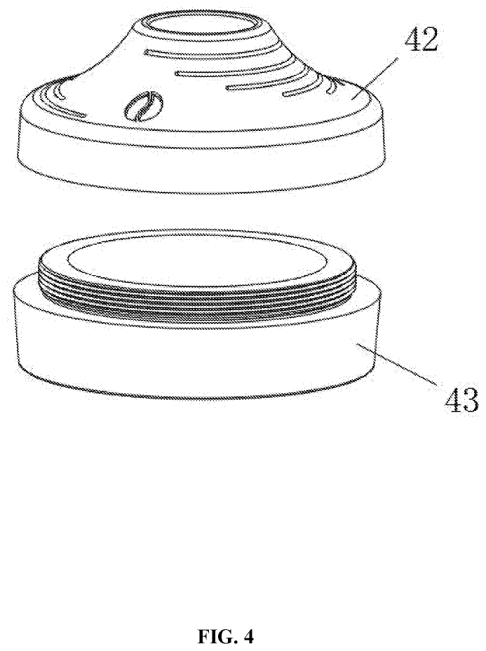

Referring to FIGS. 3 and FIG. 4, Embodiment three is different from Embodiment one in that the lid 4 in Embodiment three includes an upper lid body 42 and a lower lid body 43. Typically, the through hole 41 is defined in the top of the upper lid body 42, and the lower lid body 43 is arranged on the bottom of the upper lid body 42 and detachably connected to the upper lid body 43. The size of the lower lid body 43 can be configured as different specifications according to the sizes of a plurality of existing coffee powder boxes, so that the agitator can be adapted to coffee powder boxes of different sizes by replacing the lower lid body 43 of different specifications.

In this embodiment, the upper lid body 42 and the lower lid body 43 are detachably connected by screw threads, but in other embodiments, the detachable connection may be implemented by means of a buckle, a screw, or the like.

Exemplarily, the coffee powder stirrer further includes a spring which is sleeved on the supporting rod and is arranged between the operating member and the lid.

Exemplarily, the stirring assembly includes a connecting plate connected to the supporting rod and a plurality of stirring needles arranged on the connecting plate.

Exemplarily, the plurality of stirring needles may have different orientations and/or lengths.

Exemplarily, the plurality of stirring needles are all oriented vertically downward.

Exemplarily, the coffee powder stirrer further includes a vibration assembly which is arranged above the stirring assembly and configured to drive the stirring assembly to move upwards and collide with the lid.

Exemplarily, the vibration assembly includes a base that sleeved on the supporting rod and secured to the top of the lid, and a driving member that is mounted on the base.

Exemplarily, the stirring assembly and the vibration assembly are magnetic members.

Exemplarily, the connecting plate and/or the stirring needles each include a magnetic member.

Exemplarily, the supporting rod and the operating member are detachably connected.

Exemplarily, the supporting rod is in a threaded connection with the operating member.

Exemplarily, the coffee powder stirrer further includes a gasket that is arranged below the operating member and configured to limit a downward stroke of the operating member.

Exemplarily, the gasket is hollow and is sleeved on the supporting rod and is arranged between the operating member and the spring.

Exemplarily, the lid includes: an upper lid body where the through hole is defined in the top of the upper lid body; and a lower lid body arranged at a bottom of the upper lid body and detachably connected to the upper lid body.

The present utility model provides the following beneficial effects.

1. In the coffee powder stirrer provided in the present utility model, the supporting rod is configured to drive the stirring assembly to be inserted into the coffee powder so that the caked coffee powder in the coffee powder box can be broken up by 360 degrees cyclic rotation.

2. In the coffee powder stirrer provided in the present utility model, the lid is configured to fit with the edges of the coffee powder box thereby preventing coffee powder from spilling out of the coffee powder box.

3. In the coffee powder stirrer provided in the present utility model, the spring is configured to cooperate with the operating member so that the stirring assembly can be restored and the caked and glutinous coffee powder can be quickly broken up.

4. In the coffee powder stirrer provided in the present utility model, the vibration assembly is provided to shake off the coffee powder that sticks to the stirring assembly thereby reducing the coffee power loss and achieving the purpose of self-cleaning of the stirrer.

The principle of the present utility model has been described above in conjunction with embodiments. The foregoing description is intended for the mere purpose of explaining the principle of the present utility model, and is in no means to be construed as limiting the scope of protection of present utility model. Based on the description herein, other embodiments of the present utility model obtained by those skilled in the art without making creative efforts shall all fall in the scope of the present utility model.

What is claimed is:

1. A coffee powder stirrer, comprising:
a lid, wherein a top of the lid is provided with a through hole;
a supporting rod, inserted through the through hole, wherein one end of the supporting rod protrudes out of the top of the lid;
an operating member, mounted onto a part of the supporting rod that protrudes out of the top of the lid, wherein the operating member is configured to drive the supporting rod into motion; and
a stirring assembly, mounted on the supporting rod and disposed in a cavity of the lid.

2. The coffee powder stirrer of claim 1, further comprising a spring sleeved on the supporting rod and arranged between the operating member and the lid.

3. The coffee powder stirrer of claim 1, wherein the stirring assembly comprises:
a connecting plate, connected to the supporting rod; and
a plurality of stirring needles, arranged on the connecting plate.

4. The coffee powder stirrer of claim 3, wherein the plurality of stirring needles have different orientations and/or lengths.

5. The coffee powder stirrer of claim 3, wherein the plurality of stirring needles are oriented vertically downward.

6. The coffee powder stirrer of claim 3, further comprising a vibration assembly arranged above the stirring assembly and configured to drive the stirring assembly to move upwards and collide with the lid.

7. The coffee powder stirrer of claim 6, wherein the vibration assembly comprises:
a base, sleeved on the supporting rod and secured to the top of the lid; and
a driving member, mounted on the base.

8. The coffee powder stirrer of claim 4, wherein the stirring assembly and the vibration assembly each comprise a magnetic member.

9. The coffee powder stirrer of claim 1, further comprising a gasket, which is arranged under the operating member and is configured to limit a downward stroke of the operating member, wherein the gasket is hollow and is sleeved on the supporting rod and is arranged between the operating member and the spring.

10. The coffee powder stirrer of claim 1, wherein the lid comprises:
an upper lid body, wherein the through hole is defined in the top of the upper lid body; and
a lower lid body, arranged at a bottom of the upper lid body and detachably connected to the upper lid body.

11. The coffee powder stirrer of claim 3, wherein the lid comprises:
an upper lid body, wherein the through hole is defined in the top of the upper lid body; and
a lower lid body, arranged at a bottom of the upper lid body and detachably connected to the upper lid body.

12. The coffee powder stirrer of claim 5, wherein the lid comprises:
an upper lid body, wherein the through hole is defined in the top of the upper lid body; and
a lower lid body, arranged at a bottom of the upper lid body and detachably connected to the upper lid body.

13. The coffee powder stirrer of claim 9, wherein the lid comprises:
an upper lid body, wherein the through hole is defined in the top of the upper lid body; and
a lower lid body, arranged at a bottom of the upper lid body and detachably connected to the upper lid body.
